(19) United States
(12) Patent Application Publication
(10) Pub. No.: US 2017/0176809 A1
(43) Pub. Date: Jun. 22, 2017

(54) Anti-Peep Structure, Display Panel, Backlight Module and Display Device

(71) Applicant: BOE TECHNOLOGY GROUP CO., LTD., Beijing (CN)

(72) Inventors: Defeng MAO, Beijing (CN); Wenbo LI, Beijing (CN)

(21) Appl. No.: 15/122,299

(22) PCT Filed: Jan. 20, 2016
(86) PCT No.: PCT/CN2016/071439

§ 371 Date: Aug. 29, 2016

(30) Foreign Application Priority Data
Aug. 6, 2015 (CN) 201510477840.1

(51) Int. Cl. G02F 1/1335; G02F 1/133; G02F 1/13

(52) U.S. Cl. CPC G02F 1/133512; G02F 1/133524; G02F 1/1323; G02F 1/133; G09G 2358/00; G02F 2001/133562; G09G 2320/028; G02F 2001/133388

(57) ABSTRACT

The present application provides an anti-peep structure, a display panel, a backlight module and a display device, belongs to the field of display technology and can solve the problem in which the display device cannot realize anti-peep display in a part of the display region. The anti-peep structure in the present application comprises: at least one transmitting region configured to transmit light irradiated thereto; and at least one anti-peep region, which includes an anti-peep device configured to perform an anti-peep process on light irradiated thereto so that the light only can be viewed at a specific position. The anti-peep structure in the present application is provided with at least one anti-peep region and at least one transmitting region, the anti-peep region comprises an anti-peep device which is capable of realizing an anti-peep display without influencing transmitting of light in the transmitting region.

### FIELD

The present invention relates to the field of display technology, and particularly to an anti-peep structure, a display panel, a backlight module and a display device.

### BACKGROUND

With the progress of science and technology, portable display devices are becoming more and more popular, for example, when a person is riding in or waiting for a bus, he/she usually reads, learns or communicates through SMS by using a mobile phone or a tablet computer, however, since there are many people in the bus, contents displayed on his/her mobile phone or tablet computer may be peeped by neighbors, and the contents may be leaked out, so that privacy of his/her own cannot be protected, therefore inconvenience may be brought to him/her. At present, in the market, the user's privacy is generally protected by bonding an anti-peep sheet on the display device.

The inventor found at least following problems in the existing anti-peep technology: in the prior art, the display device performs anti-peep display on the whole display region, but anti-peep display on a part of the display region cannot be realized. For example, when a personal user's display device (for example, a mobile phone) displays a video for the public, if a private content such as a short message or WeChat message of his/her own occurs, it is desired to realize anti-peep display on a part of the display region displaying the private content, however, existing apparatuses cannot realize a display in which an anti-peep display on a part of the display region of the screen displaying the private content is realized and the other part of the display region of the screen may continue to display the video to others.

### SUMMARY

In view of the problem in the prior art that a display device cannot realize anti-peep display on a part of the display region, the present application provides an anti-peep structure, a display panel, a backlight module and a display device, which can realize anti-peep display on a part of the display region.

The present application provides an anti-peep structure comprising:

at least one transmitting region configured to transmit light irradiated thereto; and

at least one anti-peep region, which includes an anti-peep device configured to perform an anti-peep process on light irradiated thereto so that the light only can be viewed at a specific position.

Optionally, the transmitting region is made of a transparent material.

Optionally, the transmitting region has a same thickness as that of the anti-peep region.

Optionally, the anti-peep device includes any one or more of a shutter anti-peep device, a liquid crystal lens anti-peep device, a grating anti-peep device and an optical fiber glass anti-peep device.

The present application further provides a display panel comprising the above anti-peep structure.

Optionally, the anti-peep structure is provided at a light emerging side of the display panel.

Optionally, the display panel is any one of an OLED display panel, an electronic paper display panel and a liquid crystal display panel, and the anti-peep structure is provided at a light emerging side of the display panel.

The present application further provides a backlight module comprising a light guide plate, wherein the backlight module further comprises the above anti-peep structure, and wherein the anti-peep structure is provided at the outside of a light emerging side of the light guide plate.

The present application further provides a display device comprising the above display panel or backlight module.

Optionally, the display device further comprises a control unit for controlling on or off of the anti-peep device.

Optionally, the control unit comprises a fingerprint identification system for identifying a fingerprint, and controls on or off of the anti-peep device according to a result of fingerprint identification.

Optionally, the anti-peep device is configured to change light emerging direction of the anti-peep region, and the control unit is further configured to control light emerging direction of the anti-peep device.

Optionally, the display device further comprises a touch unit, wherein the control unit is configured to control light emerging direction of the anti-peep device according to touch direction and/or touch time detected by the touch unit.

Optionally, the anti-peep device includes a shutter anti-peep device, the shutter anti-peep device includes a shutter layer, and the control unit is configured to control deflection direction of the shutter layer.

Optionally, the anti-peep device is a liquid crystal lens anti-peep device, and the control unit is configured to control deflection direction of liquid crystal molecules.

The present application further provides a backlight module comprising a plurality of LED lamps, wherein the backlight module further comprises at least one anti-peep region and a control unit, and wherein the control unit controls the number of the LED lamps to be lighted in the anti-peep region, light intensities of the LED lamps, so that light emerged from the anti-peep region only can be viewed at a specific position.

The present application further provides a display device comprising the above backlight module.

The anti-peep structure in the present application is provided with at least one anti-peep region and at least one transmitting region, the anti-peep region comprises an anti-peep device which is capable of realizing an anti-peep display without influencing transmitting of light in the transmitting region. The anti-peep structure in the present application may be adopted in a display device so that the anti-peep display may be realized in a part of the display region of the display screen and a normal display is performed in the other part of the display region. The anti-peep structure in the present application is applicable to various display panels, backlight modules and display devices.

### BRIEF DESCRIPTION OF THE DRAWINGS

FIG. 1 is a structural diagram of an anti-peep structure in a second embodiment of the present application;

FIG. 2 is a structural diagram of a display panel in a third embodiment of the present application; and

FIG. 3 is another structural diagram of a display panel in the third embodiment of the present application.

### DESCRIPTION OF REFERENCE NUMERALS

1—anti-peep structure; 11—anti-peep region; 110—anti-peep device; 111—shutter anti-peep device; 112—liquid crystal lens anti-peep device; 12—transmitting region; 2—display panel.

### DETAILED DESCRIPTION OF THE EMBODIMENTS

To make persons skilled in the art better understand the solutions of the present application, the present application will be described in detail below in conjunction with the accompanying drawings and specific embodiments.

### First Embodiment

The present application provides an anti-peep structure comprising:

at least one transmitting region configured to transmit light irradiated thereto; and

at least one anti-peep region, which includes an anti-peep device configured to perform an anti-peep process on light irradiated thereto so that the light only can be viewed at a specific position.

The anti-peep process is a process in which visual angle of the display region is reduced, that is, contents on the display region can be viewed only at a specific angle, but when viewing at other angles, contents displayed on the display region is blurring. For example, the anti-peep process can be realized by changing direction, polarization direction and brightness of light.

The anti-peep structure in the present application is provided with at least one anti-peep region and at least one transmitting region, the anti-peep region is capable of performing an anti-peep process on light irradiated thereto without influencing transmitting of light in the transmitting region. The anti-peep structure in the present application may be adopted in a display device so that the anti-peep display may be realized in a part of the display region of the display screen and a normal display is performed in the other part of the display region. The anti-peep structure in the present application is applicable to various display panels, backlight modules and display devices.

### Second Embodiment

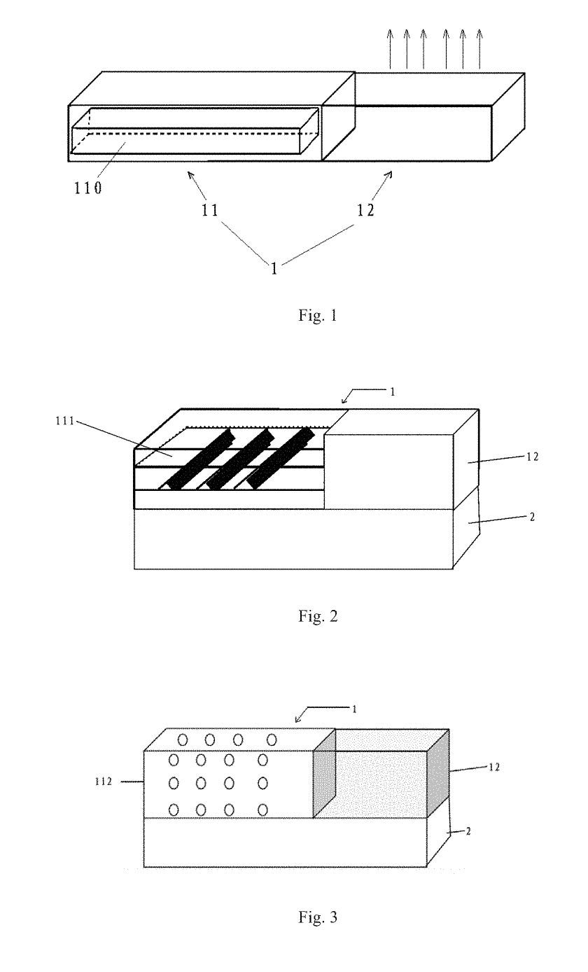

As shown in FIG. 1 to FIG. 3, this embodiment provides an anti-peep structure 1, which comprises at least one transmitting region 12 and at least one anti-peep region 11. The transmitting region 12 is configured to transmit light irradiated thereto. The anti-peep region 11 comprises an anti-peep device 110 capable of performing an anti-peep process on light irradiated thereto.

That is to say, the anti-peep structure 1 in the present embodiment is provided with at least one anti-peep region 11 and at least one transmitting region 12, the anti-peep region 11 is capable of performing the anti-peep process on light irradiated thereto without influencing transmitting of light in the transmitting region 12. The anti-peep structure 1 in the present embodiment may be adopted in a display device so that the anti-peep display may be realized in a part of the display region of the display screen and a normal display is performed in the other part of the display region. The anti-peep structure 1 in the present invention is applicable to various display panels, backlight modules and display devices.

Optionally, the transmitting region 12 is made of a transparent material.

That is to say, since the anti-peep region 11 is provided with the anti-peep device 10 and the anti-peep region 11 is only provided at a part of the display screen needing to display in an anti-peep manner, in order to ensure the flatness of the display screen, the other region of the display screen for displaying normally is filled with a transparent material. The transparent material may be any one selected from a group consisting of indium tin oxide (ITO), polystyrene (PS), poly methyl methacrylate (PMMA), polycarbonate (PC) and polysulfone (PSF or PSU) and the like.

Optionally, the transmitting region 12 has a same thickness as that of the anti-peep region 11.

That is to say, the thickness of a part of the display region of the display screen, which is needed to display in the anti-peep manner and in which the anti-peep structure is provided, is the same as that of the other part of the display region for displaying normally, so as to ensure the flatness of the whole of the display screen and the anti-peep structure.

Optionally, the anti-peep device 110 comprises any one or more of a shutter anti-peep device 111, a liquid crystal lens anti-peep device 112, an In cell multi-domain anti-peep device (in which pixel domains with wide or narrow view angles are controlled respectively, so that brightness ratios in different regions allow a front viewer to normally use the display device, but viewers at other angles are disturbed by brightness obtained by other brightness ratios, thus an anti-peep display can be realized), a grating anti-peep device and an optical fiber glass anti-peep device.

### Third Embodiment

As shown in FIG. 1 to FIG. 3, the present embodiment provides a display panel 2 comprising the anti-peep structure 1 in the second embodiment.

The anti-peep structure 1 may he provided on a surface of the display panel 2 (on cell), or may be provided in the display panel 2 and becomes a part of the display panel 2.

The configuration in which the anti-peep structure 1 is provided on the surface of the display panel 2 is preferable, facilitating to flexibly control the anti-peep structure 1 when touching, in this case, the anti-peep structure 1 is provided at a light emerging side of the display panel 2.

Optionally, the display panel is any one of an OLED display panel, an electronic paper display panel and a liquid crystal display panel, and the anti-peep structure is provided at a light emerging side of the display panel. Optionally, the display panel 2 is a touch display panel.

The display panel 2 in this embodiment can realize an anti-peep display at a part of the display region of the display panel and the other part of the display region of the display panel can display normally.

### Fourth Embodiment

The present embodiment provides a backlight module comprising the anti-peep structure in the second embodiment.

Optionally, the backlight module comprises a light guide plate, wherein the light guide plate has a light emerging side, and the anti-peep structure is provided at the outside of the light emerging side of the light guide plate.

Furthermore, as another implementation of the present embodiment, an anti-peep BLU (anti-peep backlight unit) may be adopted, wherein by means of a design of sensor and circuit, the number of LED lamps to be lighted and light intensities of the LED lamps in the backlight module are controlled to form an anti-peep region, positions of the LED lamps to be lighted and brightness values of the LED lamps are associated with a direction in which a finger slides on the screen and a time for which the finger stays on the screen, thus an anti-peep display can be realized in a part of the display region.

### Fifth Embodiment

The present embodiment provides a display device comprising the display panel in the third embodiment or the backlight module in the fourth embodiment.

That is to say, the display device adopting the display panel in the third embodiment or the backlight module in the fourth embodiment can realize an anti-peep display at a part of the display region and the other part of the display region can display normally.

Optionally, the display device further comprises a control unit for controlling on or off of the anti-peep device 110.

That is to say, the anti-peep structure 1 controls on or off of the anti-peep through the control unit. In a specific application, when a personal user's display device (for example, a mobile phone) is normally displaying a video for the public, the anti-peep region 11 of the anti-peep device 110 is in an off state, and the display device displays normally. If private content such as new short message or WeChat message of the personal user needs to be displayed in this region at this time, an anti-peep display is activated by the anti-peep structure 1, the private content is displayed in the anti-peep region 11 in an anti-peep manner, and only the personal user can view the content displayed in the anti-peep region 11, others cannot view the private content displayed in the anti-peep region 11. Meanwhile, the display region being displaying the video for the public is narrowed within the transmitting region 12, that is, the other part of the display region of the display screen may continue to display the video to the public without influencing other's viewing.

Optionally, the control unit comprises a fingerprint identification system for identifying a fingerprint, and controls on or off of the anti-peep device 110 according to a result of fingerprint identification.

That is to say, the personal user is identified by using the fingerprint identification system so as to decide whether an anti-peep display will be performed in the anti-peep region or not. This way is more convenient and safe. The personal user's fingerprint information has been registered in the fingerprint identification system in advance, every time the user wants to active the anti-peep display by inputting fingerprint, the fingerprint identification system may process the inputted fingerprint image, so as to determine whether the user is a personal user registered in the fingerprint identification system. Specifically, the fingerprint identification system matches feature of the inputted fingerprint with feature of the personal user's fingerprint registered in the fingerprint identification system in advance, if the match is succeed, it is determined that the user is the registered personal user, if the match is failed, it is determined that the user is not the registered personal user.

Optionally, the anti-peep device 110 is configured to change light emerging direction of the anti-peep region, and the control unit is further configured to control light emerging direction of the anti-peep device 110.

That is to say, the private content in the anti-peep region 11 is anti-peeped for viewers in certain directions, when the personal user activates the anti-peep display to read the private content, the personal user can view the private content in his viewing direction, but others in other viewing directions cannot view the private content.

Optionally, the display device further comprises a touch unit, wherein the control unit is configured to control light emerging direction of the anti-peep device 110 according to touch direction and/or touch time detected by the touch unit.

That is to say, the personal user touches the screen when activating the anti-peep display, if the match of fingerprint is succeed, it is determined that the user is the registered personal user, and then, the display device controls the light emerging direction of the anti-peep device 110 according to touch direction and/or touch time, so as to adjust the visual direction of the anti-peep display, thus the personal user can view the private content, but others cannot view the private content. Specifically, the personal user only needs to adjust the direction of touch operation to be consistent with a direction in which the user can easily view the screen, if the touch time is long, included angle between the visual direction and the normal direction of the display screen of the display device is increased. The way in which the display device controls the light emerging direction of the anti-peep device 110 according to touch direction and/or touch time is not limited to above way, for example, it is also possible to adjust the direction of touch operation to be contrary to a direction in which the user can easily view the screen, if the touch time is long, included angle between the visual direction and the normal direction of the display screen of the display device is reduced.

Optionally, the anti-peep device 110 includes a shutter anti-peep device 111, the shutter anti-peep device 111 includes a shutter layer, and the control unit is configured to control deflection direction of the shutter layer.

That is to say, as shown in FIG. 2, the anti-peep structure 1 is provided at the light emerging side of the display panel 2, and the anti-peep region 11 of the anti-peep structure 1 adopts the shutter anti-peep device 111, by means of a design of sensor and circuit, the deflection direction of the shutter is associated with a direction in which the personal user's finger slides on the screen, and the deflection angle of the shutter is associated with a time for which the personal user's finger stays on the screen.

Optionally, the anti-peep device is a liquid crystal lens anti-peep device 112, and the control unit is configured to control deflection direction of liquid crystal molecules.

That is to say, as shown in FIG. 3, the anti-peep structure 1 is provided at the light emerging side of the display panel 2, and the anti-peep region 11 of the anti-peep structure 1 adopts the liquid crystal lens anti-peep device 112, by means of a design of sensor and circuit, the deflection direction of the liquid crystal molecules is associated with a direction in which the personal user's finger slides on the screen, and the deflection angle of the liquid crystal molecules is associated with a time for which the personal user's finger stays on the screen.

in the above embodiments, while only an anti-peep structure comprising one transmitting region and one anti-peep region is shown, a person skilled in the art should understand that, the anti-peep structure may further comprise a plurality of transmitting regions and/or a plurality of anti-peep regions, since the anti-peep regions can be realized in a same manner, which will not described here one by one.

Obviously, implementations of the above embodiments may have many changes: for example, the display device may be any product or component with display function such as a liquid crystal display panel, an electronic paper, an OLED panel, a mobile phone, a tablet computer, a TV, a display, a notebook computer, a digital frame, a navigator, or the like.

It can be understood that the foregoing implementations are merely exemplary implementations used for describing the principle of the present application, but the present application is not limited thereto. Those of ordinary skill in the art may make various variations and improvements without departing from the spirit and essence of the present application, and these variations and improvements shall fall into the protection scope of the present application.

1. An anti-peep structure comprising:
at least one transmitting region configured to transmit light irradiated thereto; and
at least one anti-peep region, which includes an anti-peep device configured to perform an anti-peep process on light irradiated thereto so that the light only can be viewed at a specific position.

2. The anti-peep structure of claim 1, wherein the transmitting region is made of a transparent material.

3. The anti-peep structure of claim 1, wherein the transmitting region has a same thickness as that of the anti-peep region.

4. The anti-peep structure of claim 1, wherein the anti-peep device includes any one or more of a shutter anti-peep device, a liquid crystal lens anti-peep device, a grating anti-peep device and an optical fiber glass anti-peep device.

5. A display panel comprising the anti-peep structure of claim 1.

6. The display panel of claim 5, wherein the anti-peep structure is provided at a light emerging side of the display panel.

7. The display panel of claim 5, wherein the display panel is any one of an OLED display panel, an electronic paper display panel and a liquid crystal display panel, and the anti-peep structure is provided at a light emerging side of the display panel.

8. A backlight module comprising a light guide plate, wherein the backlight module further comprises the anti-peep structure of claim 1, and wherein the anti-peep structure is provided at the outside of a light emerging side of the light guide plate.

9. A backlight module comprising a plurality of LED lamps, wherein the backlight module further comprises at least one anti-peep region and a control unit, and wherein the control unit controls the number of the LED lamps to be lighted in the anti-peep region, light intensity of the LED lamps, so that light emerged from the anti-peep region only can be viewed at a specific position.

10. A display device comprising the display panel of claim 5.

11. The display device of claim 10, further comprising a control unit for controlling on or off of the anti-peep device.

12. The display device of claim 11, wherein the control unit comprises a fingerprint identification system for identifying a fingerprint, and controls on or off of the anti-peep device according to a result of fingerprint identification.

13. The display device of claim 11, wherein the anti-peep device is configured to change light emerging direction of the anti-peep region, and the control unit is further configured to control light emerging direction of the anti-peep device.

14. The display device of claim 13, further comprising a touch unit, wherein the control unit is configured to control light emerging direction of the anti-peep device according to touch direction and/or touch time detected by the touch unit.

15. The display device of claim 13, wherein the anti-peep device includes a shutter anti-peep device, the shutter anti-peep device includes a shutter layer, and the control unit is configured to control deflection direction of the shutter layer.

16. The display device of claim 13, wherein the anti-peep device is a liquid crystal lens anti-peep device, and the control unit is configured to control deflection direction of liquid crystal molecules.

17. A display device comprising the backlight module of claim 8.

18. The display device of claim 17, further comprising a control unit for controlling on or off of the anti-peep device.

19. The display device of claim 18, wherein the control unit comprises a fingerprint identification system for identifying a fingerprint, and controls on or off of the anti-peep device according to a result of fingerprint identification.

20. A display device comprising the backlight module of claim 9.
